(19) United States
(12) Patent Application Publication
(10) Pub. No.: US 2006/0164493 A1
(43) Pub. Date: Jul. 27, 2006

(54) Ink-jet recording sheet

(75) Inventor: Kenzo Kasahara, Tokyo (JP)

Correspondence Address: LUCAS & MERCANTI, LLP, 475 PARK AVENUE SOUTH, 15TH FLOOR, NEW YORK, NY, 10016, US

(73) Assignee: Konica Minolta Photo Imaging, Inc.

(21) Appl. No.: 11/333,443

(22) Filed: Jan. 17, 2006

(30) Foreign Application Priority Data
Jan. 24, 2005 (JP) JP2005-015260

(51) Int. Cl. B41J 2/01

(52) U.S. Cl. 347/105

(57) ABSTRACT

An ink-jet recording sheet containing a titanium oxide particles at the outermost surface thereof in which the fumed titania particles and have a primary particle diameter of not more than 20 nm.

This application is based on Japanese Patent Application No. 2005-015260 filed on Jan. 24, 2005, in Japanese Patent Office, the entire content of which is hereby incorporated by reference.

### FIELD OF THE INVENTION

The present invention relates to an ink-jet recording sheet excellent in the coloring ability and glossiness uniformity.

### BACKGROUND OF THE INVENTION

In the ink-jet recording system, various investigations have been carried out also on the ink, and pigment ink is recently noticed. Various patent applications have been applied which disclose problems and solving means about the pigment ink. The pigment ink is superior to dye ink in the durability such as light fastness, anti-ozone ability and anti-spreading ability, and a drawback of color reproducibility is also improving. It is pointed out, however, that the pigment ink is inferior a little in the uniformity of glossiness, and the surface is very unnatural for appreciating as a photographic picture since the medium density area is glare and the glossiness is lowered in the high density area. For canceling such the unnaturality, it is tried that the surface of the picture is made to semi-matt by using embossed substrates for unifying the surface glossiness. However, the glare in the medium density area is difficultly dissolved such the contrivance.

Besides, titania or titanium oxide is investigated for using as the inorganic fine particle in the recording sheet similarly to silica and alumina, in Japanese Patent No. 2673840. However, the purpose of the investigation is almost to use for controlling the whiteness, shielding UV rays and applying as photo-catalyst and the investigation for use for raising the glossiness is very few.

Japanese Patent Publication Open to Public Inspection (hereafter referred to as JP-A) No. 2001-328341 discloses a contrivance for raising the glossiness by the use of spherical particle having a refractive index of not less than 1.65, and JP-A 2001-10212 discloses a recording sheet improved in the image coloring ability and the strength of the coated layer by the use of titanium oxide and colloidal silica. However, any recording sheet superior in the ink absorbing speed has not been obtained. Any examination for raising the uniformity of glossiness by the pigment ink is almost not found, and actual examination about the use of fumed titania (hereafter also referred to as titania) is very few.

### SUMMARY OF THE INVENTION

An object of the invention is to provide a recording sheet which has high surface glossiness and rapid ink absorbability, and is superior in the uniform glossy feeling when the pigment ink is applied, and displays superior coloring ability even when printed by a dye ink.

The above object of the invention is attained by the following means.

(1) An ink-jet recording sheet containing titanium oxide particles at the outermost surface thereof wherein the titanium oxide particles are the fumed titania particles and have a primary particle diameter of not more than 20 nm.

(2) The ink-jet recording sheet of claim 1, wherein the recording sheet has-two or more ink receiving layers on a support and the layer constituting the outermost ink receiving surface contains the fumed titania particles having a primary particle diameter of not more than 20 nm, and has a thickness of from 0.1 to 5 μm.

(3) The ink-jet recording sheet of claim 2, wherein the layer constituting the ink receiving outermost surface contains the fumed titania particles having a primary particle diameter of not more than 20 nm, and has a thickness of from 0.1 to 5 μm, and is formed by simultaneously coated with the adjacent ink receiving layer.

(4) The ink-jet recording sheet of claims 1, wherein the layer containing the fumed titania particles contains a cationic compound.

(5) The ink-jet recording sheet of claim 4, wherein the cationic compound is basic polyaluminum chloride.

A recording sheet can be obtained by the invention which has high the surface glossiness and rapid ink absorbability, and is superior in the uniform glossy feeling when the pigment ink, and displays superior coloring ability even when printed by a dye ink.

### DESCRIPTION OF THE PREFERRED EMBODIMENTS

Though the best embodiment for actualizing the invention is described below, the embodiment of the invention is not limited to it.

The pigment ink is superior to the dye ink in the fastness and the coloring ability regarded as a shortcoming is in the course of improvement. However, there are some problems such as the insufficient uniformity in the glossiness feeling of the surface of the printed image, the glaring in the medium density area and the lowering of glossiness in the high density area. Particularly, the problem of the glaring in the medium density area is difficultly solved.

It is supposed that the cause of the glaring in the medium density area of the printed image by the pigment ink is as follows. Namely, the porous type ink receiving layer of usual ink-jet recording sheet is mainly composed of silica or alumina and pores. Therefore, the refractive index of the porous layer constituted by combining them is as low as about 1.1 to 1.4. When a layer of the pigment ink composed of dried solid ingredients of the ink other than the volatile components is formed on the porous layer, the reflection of light is strengthen at the interface from the layer having higher refractive index to the layer having lower refractive index because the layer containing the pigment having a refractive index of approximately 1.5 is formed on the porous layer having a lower refractive layer of from about 1.1 to 1.4, and the glaring is resulted. In the invention, the glaring is inhibited by raising the refractive index of the outermost layer by the use of titanium oxide particles having high refractive index in the outermost layer.

Silica and alumina each produced by a gas method (called fumed silica and alumina) are very commonly used in the ink-jet recording sheet as the inorganic particle. The fumed silica and alumina are suitable for ink absorption since they have higher surface activity than those produced by a wet method and easily form a highly porous structure. It is supposed and confirmed by the inventor that the fumed titania is advantageous in the ink absorption, particularly in the absorption speed, because the layer of the fumed titania has higher pores ratio compared with the layer constituted by titania produced by a wet method such as a precipitation method and a sol-gel method.

Moreover, the surface glossiness is also raised by constituting the outermost layer by the titanium oxide because it has high refractive index.

Consequently, the ink-jet recording sheet according to the invention is constituted by forming an ink receiving layer on a support, and the outermost ink receiving layer contains titanium oxide particles synthesized by a vapor deposited method and having a primary particle diameter of not more than 20 nm.

The ink receiving layer includes a porous layer comprising the fine particles and hydrophilic binder, and the absorbing layer containing the titania and the hydrophilic binder either may be a layer according to the invention containing the fumed titania or a layer constituted by forming the outer layer containing the fumed titania and the hydrophilic binder and having a designated thickness on another porous ink receiving layer containing another inorganic particle such as silica (it may be titania).

In the preferable embodiment, the porous layer containing the titania by the vapor deposited method and the hydrophilic binder is provided on the porous layer containing at least one kind of inorganic particle other than the titania and the hydrophilic binder.

An example of the fumed titania is described in JP-A No. 11-278845, for example. The titanium oxide can be obtained by hydrolyzing titanium tetrachloride at high temperature in an oxygen-hydrogen flame. The particle diameter can be controlled by controlling known conditions and the particle diameter of not more than 20 nm necessary for the invention can be easily obtained. The diameter of the primary particle of the fumed titania to be employed in the invention is from 3 to 20 nm, and preferably 5 to 15 nm. When the size of the primary particle is too large, the light scattering caused by the high refractive index of the titania is increased so that the coloring ability by the dye ink printing is lowered. When the primary particle diameter is too small, the ink absorbing speed is decreased by the reduction of the diameter of capillary. The particle diameter in the invention can be determined by observing the particle itself or cross section of surface of the ink receiving layer by an electron microscope, and measuring the diameters of optional several hundreds titania particles. The particle diameter is the simple average (number average) of the above measured diameters. The individual particle diameter is the diameter of the circle having the same area as the projection area of the particle.

There is a slacken reverse interrelation between the primary particle diameter and the BET specific surface area, and smaller primary particle diameter tends to correspond to larger BET specific surface area and larger primary particle diameter tends to correspond to smaller BET specific surface area. Accordingly, the BET specific surface area can be applied as an indicator for obtaining the preferable titania particles.

The BET specific surface area is preferably from 55 to 250 m²/g, and more preferably from 100 to 200 m²/g. As the titania by vapor deposited method, P25 having a primary particle diameter of 21 nm and a BET specific surface area of 50 m²/g, manufactured by Nihon Aerogil Co., Ltd., is available on the market, but this product is not suitable for the invention since the particle diameter is too large. Titania having a BET specific surface area of from 55 to 150 m²/g described in JP-A 11-278845 is preferably employed. One having a specific area of 150 m²/g is particularly preferred.

The BET specific surface area is a value determined by a gas adsorption method. In such the method, the specific surface area of a particle is calculated from the amount of adsorbed gas when a gas having known occupying area such as nitrogen is adsorbed to the particle to be measured. The BET specific surface area is a value for exactly expressing the amount or monomolecular layer adsorbing amount of the gas molecular directly adsorbed onto a solid surface which is calculated by the following expression.

As is shown below, the expression of BET expresses the relation between the absorption equilibrium pressure P in the adsorption equilibrium stat at a constant temperature and the adsorption amount V at the pressure.
P/V(P₀−P)=(1/VmC)+((C−1)/VmC)(P/P₀)

In the above expression,
P₀: Saturated vapor pressure
Vm: Adsorbed amount of adsorbed monolayer; the adsorbed amount a gas when the gas forms a monomolecular layer on a solid surface
C: Parameter relating to adsorption heat (>0)

The surface area can be obtained by calculating the monomolecular layer adsorption amount Vm according to the above expression and multiplying the Vm by the cross section area occupied by one molecule of the gas.

In a concrete example of measurement of the BET specific surface area, a sample was pretreated for degassing for 10 hours at 50° C., and the gas adsorbed amount is measured by a gas adsorption amount measuring apparatus employing nitrogen gas as the adsorbing gas. As the full-automatic gas adsorption amount measuring apparatus, Autosorp 1, manufactured by Uasa Ionics Co., Ltd., and Flowsorp 2300, manufactured by Shimadzu Seisakusho Co., Ltd., are applicable. In such the measuring apparatuses, the BET specific surface area is determined by an one-point method or multi-point method of the nitrogen adsorption method.

It is required to inhibit the using amount of the fumed titania from the view point of the cost as long as the effects thereof is not degraded since the titania is expensive caused by the cost of titanium tetrachloride as the raw material. Furthermore, the excessively increasing in the using amount causes lowering in the transparency of the layer so that the coloring ability of the dye ink is degraded. For holding the pore volume or the ink absorption amount, the use of the titania together with the fumed silica or fumed alumina is preferable, and the use with the fumed silica is particularly preferred.

The glossiness and the uniformity of it, a part of the effects of the invention, tends to become higher accompanied with the rising of the density of the fumed titania contained in the outermost layer. Namely, in the preferable embodiment of the invention, the layer has a multi-layer structure in which the outermost layer contains the fumed titania in high density and the layer adjacent to the outermost layer or a lower layer contains mainly contains the fumed silica and substantially no titania, and the outermost layer is made as thin as possible. The thickness of the outermost layer is preferably from 0.1 to 5 μm, and more preferably from 0.5 to 2.5 μm. It is most preferable that any other inorganic particle is not contained in the outermost layer for holding the ink absorbing amount and sufficiently raising the glossiness.

It is necessary that the primary particle diameter of the invention is not more than 20 nm for coating such the thin layer.

For thin layer coating, the wet thickness of the layer is set rather thin, but the stability of coating is degraded when the wet thickness is made to too thin. Besides, the content of the fumed titania becomes lower for keeping the wet thickness capable of being stably coated. Though the viscosity of the coating liquid is also important factor of the stable coating, the viscosity of the coating liquid tends to become lower when the concentration of the fumed titania is lowered so that the coating of the thin layer and the stable coating are difficultly consistent. As the means for raising the viscosity of the coating liquid, a thickner such as water-soluble polymer is easily thought. The water soluble polymer such as polyvinyl alcohol is always employed for the binder of the inorganic particle layer. Therefore, the viscosity of the coating liquid can be raised by increasing the amount of the polyvinyl alcohol. However, the amount of such the water-soluble polymer cannot be carelessly increased because the polymer is swollen on the occasion of absorbing the ink so as to hinder the ink absorption. The decreasing in the diameter of the primary particle is necessary for stabilizing the thin layer coating and holding the ink absorbing ability. Namely, the viscosity of the coating liquid is raised by that the adsorbing sites of the particle with the water-soluble polymer is increased accompanied with reducing of the particle diameter. Consequently, high viscosity of the coating liquid can be obtained by lower concentration.

As the method for forming the outermost layer, a method can be considered in which a lower layer is once coated and dried and then the outermost layer is coated and dried. This method, however, causes rising in the cost accompanied with the increasing in the number of process, and frequently cause light interference by the thin layer. The light interference is a phenomenon commonly observed in a thin layer having a thickness of several times of half-wavelength of light and differing from the adjacent medium in the refractive index, and the thin layer is colored in red, green or yellow. The kind of the color is depended on the layer thickness and the layer having uniform thickness causes uniform monocolor. A method in which the outermost layer is coated on the lower adjacent layer after the coating and before drying thereof or a method in which the outermost layer is coated simultaneously with the coating of the adjacent layer are preferable for avoiding the interference phenomenon because the two layers are slightly mixed at the interface so that the interface acting as the reflecting face is burred. Furthermore, slight irregularity is formed in the thickness of the outermost layer. Therefore, various colors light are mixed so that the surface is appeared white even though the surface microscopically reflects monocolor light at each of the parts. The simultaneously multilayer coating is particularly superior in such the effects.

It is preferable that the layer containing the titanium oxide additionally contains a cationic compound. The cationic compound is preferably used for improving the water resistivity and humid resistivity of prints by the dye inks, and is also effective in the printing by the pigment ink for providing the ant-abrasion ability.

The outermost layer containing the fumed titania according to the invention preferably contains the cationic compound since the outermost layer is frequently contacted with the dye or the pigment.

As the cationic compound, cationic polymers are usable, and other preferable ones are basic aluminum compounds.

For adding the cationic compound, a method is preferable in which the fumed titania is added to an aqueous solution containing the cationic compound or a dispersion thereof, and then the resultant mixture is dispersed to obtain a dispersion. After that, the binder such as a water-soluble polymer is added to the dispersion to prepare a coating liquid and then thus obtained coating liquid is coated and dried.

Examples of the cationic polymer include polymers each having a primary, secondary or tertiary amine or a quaternary ammonium base on the main chain or side chain which are described in JP-A 59-20696, 59-33176, 59-33177, 59-155088, 59-11389, 60-49990, 60-83882, 60-109894, 62-198493, 63-49478, 63-115780 and 63-280681, and JP-A 1-40371, 6-234268, 7-125411 and 10-193776. Ones substantially water-soluble are preferable from the viewpoint of the facility of production.

Moreover, polyethyleneimine, polyallylamine, polyvinylamine, dicyanodiamido-polyalkylene-polyamine condensate, polyalkylenepolyamine-dicyanediamidoammonium salt condensate, dicyanodiamido-formaline condensate, epichlorohydrine-dialkylamine additional polymerized product, diallyldimethylammonium chloride polymer, diallyldimethyl-ammonium chloride-SO₂ copolymer, polyvinylimidazole, vinylpyrrolidone-vinylimidazole copolymer, polyvinylpyridine, polyamidine, chitosan, cationized starch, vinylbenzyl-trimethylammonium chloride polymer, (2-methacroyloxyethyl)trimethylammonium chloride polymer can be cited as other examples of the cationic polymer.

Cationic polymers described as polymer dye fixing agents in “Kagaku Kogyo Jihou”, Aug. 15 and 25, 1998, “Koubunshi Yakuzai Nyumon(Introduction to High-Molecular Agents)”, p. 787, Sanyo Kasei Kogyo Co., Ltd., 1992, further are cited as examples of the cationic polymer.

The average molecular weight of the cationic polymer is preferably from 2,000 to 500,000, and more preferably from 10,000 to 100,000.

In the invention, the molecular weight is a number average molecular weight measured by gel permeation chromatography in terms of that of polyethylene glycol.

The adding amount of the cationic polymer is from 1 to 10, and more preferably from 2 to 7, percent by weight of the fumed titania.

The cationic compound may be added to the coating liquid not only by a method in which the cationic polymer is uniformly added to the coating liquid containing the titania but also a method in which the cationic polymer is added in a state of composite particle together with the titania fine particles. The methods for preparing the composite particle include a method in which the cationic polymer is mixed with the titania fine particles so as to adsorb and cover the titania particles, a method in which the above composite particles are coagulated to form higher dimensional composite particles, and a method in which coarse particles formed by the mixing is dispersed by a dispersing machine to prepare a uniform dispersion.

The cationic polymer is generally water-soluble since it has a water-soluble group. However, some of them are insoluble in water according to the composition of the copolymerized components. The slightly soluble ones can be employed by dissolving in a water-permissible organic solvent, though the water-soluble ones-are preferable from the viewpoint of facility of the production.

The water-permissible organic solvent is an organic solvent capable of being dissolved in water in an amount of approximately not less than 10%, for example, alcohols such as methanol, ethanol, propanol and n-propanol, glycols such as ethylene glycol, Diethylene glycol and glycerol, esters such as ethyl acetate and propyl acetate, ketones such as acetone and methyl ethyl ketone, and amides such as N,N-dimethyl-formamide. In such the case, the using amount of the organic solvent is preferably smaller than that of water.

A basic polyaluminum hydroxide which is an inorganic aluminum-containing cationic polymer is employable as the cationic polymer. The basic polyaluminum hydroxide compound is water-soluble polyaluminum hydroxide which is basic and stably contains basic and high molecular weight multi-nucleus condensate ion such as [Al₆(OH)₁₅]³⁺, [Al₈(OH)₂₀]⁴⁺, [Al₁₃(OH)₃₄]⁵⁺ and [Al₂₁(OH)₆₀]³⁺, the principal component thereof is represented by the following Formulas 1, 2 or 3,
[Al₂(OH)ₙ(OH)ₙCl₁₆₋ₙ]ₙ Formula 1
[Al(OH)₃]ₙAlCl₁₃ Formula 2
Alₙ(OH)ₘCl₍₃ₙ₋ₘ₎. In the above 0<m<3n Formula 3

These compounds come on the market under the commercial name of polyaluminum chloride PAC from Taki Kagaku Co., Ltd., Polyaluminum chloride Paho from Asada Kagaku Co., Ltd., and Purachem WT from Riken Green Co., Ltd., and from other makers for the same purpose, and various grades of them can easily available. In the invention, though the commercial products may be employed without any treatment, there are ones having unsuitable low pH. Such the products can be employed after suitably controlling the pH value.

In the invention, the content of the water-soluble metal compound in the layer containing the fumed titania fine particles is from 0.1 g/m² to 10 g/m², and preferably from 0.2 g/m² to 5 g/m².

The foregoing cationic compounds may be employed in combination of two or more kinds, and the cationic polymer and the water-soluble metal compound may be employed with together.

In a preferable embodiment of the invention, the outermost layer containing the titania is formed on the surface of another ink receiving layer.

Components constituting the ink accepting layer other than the titania-containing layer are described below.

In the invention, the ink accepting layer other than the titania-containing layer is also preferably a porous layer containing an inorganic fine particle and a water-soluble binder.

As the inorganic fine particle, white pigments such as light calcium carbonate, heavy calcium carbonate, magnesium carbonate, kaolin, clay, talk, calcium sulfate, barium sulfate, titanium dioxide, zinc hydroxide, zinc sulfide, zinc carbonate, hydrotalsite, aluminum silicate, diatomite, calcium silicate, magnesium silicate, synthesized amorphous silica, colloidal silica, alumina, colloidal alumina, pseudoboehmite, aluminum hydroxide, lithopone, zeolite and magnesium hydroxide are employable. These white pigment may be employed either in the state of primary particle or a state of secondarily coagulated particle.

Among them, a fine particle of alumina and that of silica are preferable as the inorganic particle. The silica fine particle is preferably wet method-silica prepared by a precipitation method or that prepared by a vapor deposited method.

For example, wet method-silica prepared by precipitation method Finesil, manufactured by Tokuyama Co., Ltd., and that prepared by gel method Nipgel, manufactured by Nihon Silica Kogyo Co., Ltd., are available on the market. In the precipitation method-silica, primary particles each having a diameter of approximately from 10 to 60 nm form secondarily coagulated particles, and in the gel method-silica, primary particles each having a diameter of approximately from 3 to 10 nm form secondarily coagulated particles.

There is no limitation on the lower limit of the diameter of the primary particles of the wet method-silica, and the diameter is preferably not less than 3 nm from the viewpoint of the stability of production and not more than 50 nm from the viewpoint of the transparency of the layer. The gel method-silica is preferable because the primary particle diameter of tends to be smaller than that of the precipitation method-silica.

The vapor deposited silica is produced by a burning method using silicone tetrachloride as the raw material. Aerogil series comes on the market from Nihon Aerogil Co., Ltd., for example.

The vapor deposited silica is particularly preferable in the invention, by which high porosity can be obtained and coarse coagulated particle is difficultly formed on the occasion of preparation of the cationic composite particles. In the vapor deposited method-silica, the secondarily coagulated particle thereof is formed by relatively weak force and more easily dispersed compared with the wet method-silica.

The vapor deposited silica having a primary particle diameter of from 3 to 50 nm is preferable. When the diameter of the primary particle is not more than 50 nm, high glossiness of the recording sheet can be attained and the lowering in the maximum density caused by the diffused reflection can be reduced so that a clear image with high density can be obtained.

The particle diameter of the silica particles in the invention can be determined by electronmicroscopic observing the particle itself, or cross section or surface of the ink receiving layer, and measuring the diameters of optional several hundreds silica particles. The diameter is the simple average (number average) of the above measured diameters. The individual particle diameter is the diameter of the circle having the same area as the projection area of the particle.

In the particularly preferred embodiment, the porous ink receiving layer is formed by secondary or higher dimensional particles in which the average diameter of such the particles is preferably from 20 to 200 nm from the view point for obtaining the recording sheet having high ink absorbing ability and high glossiness.

It is also preferable to control the water content of the vapor deposited silica by storing the silica for 3 or more days at a humidity of from 20 to 60%.

The adding amount is usually from 5 to 30 g, and preferably from 10 to 25 g, per square meter of the recording sheet, though the amount is largely varied depending on the required ink absorbing amount, the porosity of the porous layer and the kind of the hydrophilic binder. The ratio of the silica fine particles to the hydrophilic binder in the ink receiving layer is approximately from 2:1 to 20:1, and particularly preferably from 3:1 to 10:1, in weight ratio.

Though the ink absorbing capacity is increased accompanied with the increasing in the adding amount of the silica fine particles, there is a possibility of degradation in the properties such as curling and cracking. Therefore, it is preferable to increase the capacity by increasing the porosity. The preferable porosity is from 40 to 7.5%.

The porosity can be suitably controlled by the selection of the kind of the silica fine particle and that of the hydrophilic binder, their mixing ratio, and the amount of another additive. The porosity in the invention is the ratio of the entire volume of the pores in the volume of the porous layer, which can be calculated by the entire volume of the materials constituting the layer and the thickness of the layer. The total volume of the pores can be easily determined by the measurement of the water absorbing volume.

The hydrophilic binder to be used in the ink accepting layer is described below.

The hydrophilic binders employable in the layer containing the fumed titania according to the invention can be basically applied. Examples of the hydrophilic binder include poly(vinyl alcohol), gelatin, poly(ethylene oxide), poly(vinyl pyrrolidone), casein, starch, agar, karaginan, poly(acrylic acid), poly(methacrylic acid), polyacrylamide, polymethacrylamide, poly(styrenesulfonic acid), cellulose, heydroxyethyl cellulose, carboxymethyl cellulose, hydroxyethyl cellulose, dextran, dextrin, pullulan and water-soluble poly(vinyl butyral). The hydrophilic binders can be employed in combination of two or more kinds thereof.

The hydrophilic binder preferably employable in the invention is poly(vinyl alcohol) which includes a cation-modified poly(vinyl alcohol) such as that cation-modified at the terminals thereof, an anion-modified poly(vinyl alcohol) having an anionic group and a UV crosslinking type modified poly(vinyl alcohol), additionally to ordinary poly(vinyl alcohol) produced by hydrolysis of poly(vinyl acetate).

As the poly(vinyl alcohol) produced by hydrolysis of poly(vinyl acetate), one having an average polymerization degree of not less than 1,000 is preferably employed, and one having an average polymerization degree of from 1,500 to 5,000 is particularly preferable. One having a saponification value of from 70 to 100%, particularly from 80 to 99.5%, is preferable.

The cation-modified poly(vinyl alcohol) is a poly(vinyl alcohol) having a primary, secondary or tertiary amino group or a quaternary ammonium group in the main chain or side chain thereof such as those described in JP-A 61-10483, which can be obtained by saponification of a copolymer of an ethylenic unsaturated monomer having a cationic group and vinyl acetate.

Examples of the ethylenic unsaturated monomer having the cationic group include trimethyl-7(2-acrylamido-2,2-dimethylethyl)ammonium chloride, trimethyl-(3-acrylamido-3,3-dimethylpropyl)ammonium chloride, N-vinylimidazole, N-vinyl-2-methylimidazole, N-(3-dimethylaminopropyl)-methacrylamide, hydroxylethyltrimethylammonium chloride, trimethyl-(2-methacrylamidopropyl)ammonium chloride and N-(1,1 -dimethyl-3-dimethylaminopropyl)acrylamide.

The ratio of the cation-modifying group-containing monomer in the cation-modified polyvinyl alcohol is from 0.1 to 10 mole-%, and preferably from 0.2 to 5 mole-%, of vinyl acetate.

Examples of the anion-modified polyvinyl alcohol include polyvinyl alcohol having the anionic group such as those described in JP-A No. 1-206088, copolymers of vinyl alcohol and a water soluble vinyl compound such as those described in JP-A No. 61-237681 and 63-307979 and modified polyvinyl alcohol having a water soluble group such as those described in JP-A No. 7-295265.

Example of nonionic-modified polyvinyl alcohol include polyvinyl alcohol derivatives in which a polyalkylene oxide group is added to a part of vinyl alcohol such as those described in JP-A No. 7-9758 and block copolymer of a vinyl compound having a hydrophobic group and vinyl alcohol such as those described in JP-A No. 8-25795.

Examples of the UV crosslinking type modified poly(vinyl alcohol) include polyvinyl alcohols having a photo-reactive side chain such as those described in JP-A No. 2004-262236.

Two or more kinds of the poly(vinyl alcohol) different from each other in the polymerization degree or the kind of modification may be employed with together.

The polyvinyl alcohol is preferably hardened by a hardening agent for obtaining the recording sheet of the invention excellent in the glossiness and without degradation in brittleness.

The hardening agent usable in the invention is generally a compound having a group capable of reacting with the polyvinyl alcohol or accelerating the reaction between the different groups each contained in the poly(vinyl alcohol) molecules. Examples of the hardening agent include epoxy type hardening agents such as glycidyl ethyl ether, ethylene diglycol glycidyl ether, 1,4-butanediol diglycidyl ether, 1,6-diglycidylcyclohexane, N,N-diglycidyl-4-glydidyloxy-aniline, sorbitol polyglycidyl ether and glycerol polyglycidyl ether; aldehyde type hardening agents such as formaldehyde and glyoxal; reactive halogen type hardening agents such as 2,4-dichloro-4-hydroxy-1,3,5-s-triazine; reactive vinyl type hardening agent such as 1,3,5-trisacryloyl-hexahysro-s-triazine and bisvinylsulfonyl methyl ether; boric acid and its salt; borax; aluminum alum; and isocyanate compounds. Among them, boric acid and its salt, the epoxy type hardening agents and the isocyanate compounds are preferred.

The boric acid and its salt are an oxygen acid having a boron atom as the center atom and its salt, in concrete orthoboric acid, diboric acid, metaboric acid, tetraboric acid, pentaboric acid, octaboric acid and their salts are included.

The using amount of the hardening agent is usually from 5 to 500 mg, preferably from 10 to 300 mg, per gram of poly(vinyl alcohol), though the amount is varied depending on the kind of poly(vinyl alcohol), kind of the hardening agent, kind of silica fine particle and the ratio of silica to the polyvinyl alcohol.

The hardening agent may be directly added to the coating on the occasion of coating the aqueous coating liquid for forming the ink receiving layer according to the invention, or may be supplied by over coating a solution containing the hardening agent after coating and drying of the aqueous coating liquid containing no hardening agent for forming the ink receiving layer.

In the ink-jet recording sheet according to the invention, the ink accepting layer other than the outermost layer containing the fumed titania such as the ink accepting layer containing the wet-method silica or the vapor deposited method-silica preferably contains a polyvalent metal compound.

As the polyvalent metal compound, chloride, sulfate, nitrate, formate, succinate, molonate, and chloroacetate of aluminum, calcium, magnesium, zinc, iron strontium, barium, nickel, copper, scandium, gallium, indium., titanium, zirconium, tin and lead are cited. Among them, water-soluble salt of aluminum, calcium, magnesium, zinc and zirconium are preferable since their metal ions are colorless. Water soluble zirconium compound is particularly preferable because which is superior in the anti-spreading effect during storage for long period.

Concrete examples of the water-soluble aluminum compound include polyaluminum chloride (basic aluminum chloride), aluminum sulfate, basic aluminum sulfate aluminum potassium sulfate (alum), aluminum ammonium sulfate (ammonium alum), sodium aluminum sulfate, aluminum nitrate, aluminum phosphate, aluminum carbonate, polyaluminum sulfate silicate, aluminum acetate and basic aluminum lactate. The term of “water-soluble” of the water-soluble poly-valent metal compound means that the compound is dissolved in water of 20° C. in an amount of not less than 1%, and preferably not less than 3%, by weight.

The most preferable compound is basic aluminum chloride having a basic degree of mot less than 80%, which is represented by the following molecular formula.
[Al₂(OH)_{N}Cl₆₋ₙ]ₙ

In the above, 0<n<6, and m≦10

The basic degree is represented by n/6×100 (%)

As concrete examples of the water-soluble zirconium compound, zirconium carbonate, zirconium ammonium carbonate, zirconium acetate, zirconium nitrate, zirconium oxchloride, zirconium lactate and zirconium citrate are preferred. Zirconium oxochloride and zirconium acetate are particularly preferred from the viewpoint of the anti-spreading ability during storage for long period.

In the laminated ink receiving layer containing the fumed titania and the other ink accepting layer, the amount of the water-soluble poly-valent metal compound contained in the ink accepting layer arranged at the outermost portion, hereinafter referred to as the outermost layer, is preferably from 0.1 to 1.0 g/m² in terms of the weight of the oxide of the poly-valent metal. When the amount is less than 0.1 g/m² or more than 1.0 g/m², the image density is lowered in the former case and the ink absorbing ability is lowered in the later case. In the invention, the poly-valent metal compound may be contained in the ink receiving layer other than the outermost layer. In such the case, the relation of the weight A of the water soluble poly-valent metal compound in terms of oxide of the metal contained in the outermost layer of the laminate two or more ink receiving layers and the sum of the weight B of the poly-valent metal compound in terms of oxide of the metal contained in the whole ink receiving layers other than the outermost layer [A/(A+B)] is preferably not less than 0.50,and more preferably not less than 0.60.

In the ink-jet recording sheet of the invention the ratio of the dried layer thickness of the outermost layer containing the fumed titania to that of the entire ink receiving layers including the titania-containing layer is preferably from 0.1 to 30%, and more preferably from 2 to 10%. Namely, it is preferable that the ink receiving layer is constituted by laminating two or more layers and the outermost layer contains the water-soluble poly-valent metal compound in higher concentration than the other layers.

The ink accepting layer and the fumed titania-containing layer according to the invention preferably contain a surfactant. Cation type, betaine type and nonion type hydrocarbon surfactants, fluorine-containing surfactants and silicone surfactants can be employed in the ink accepting layer. Among them, cation type and betaine type surfactants described in JP-A No. 2003-3121334 are preferable from the viewpoint of the quality of coated layer such as coating suitability and the suitability for multi-layer simultaneous coating. The using amount of the surfactant is preferably from 0.0001 to 1.0 g/m², and more preferably from 0.001 to 0.5 g/m².

A porous ink receiving layer containing the silica fine particles, the hydrophilic binder and the surfactant prepared in accordance with JP-A 11-321079 and 2000-158807 can be employed as the concrete constitution of the ink accepting layer relating to the invention additionally to the titania-containing layer.

The cationic polymer the same as those applicable for the layer containing the fumed titania are employable.

When the cationic polymer is previously added into the ink accepting layer coating liquid, the cationic polymer is not only uniformly added into the coating liquid but also may be added in a state of composite particles formed with the inorganic fine particles the same as in the foregoing titania-containing layer. The method for forming the composite particle by the inorganic fine particles and the cationic polymer may be a method in which the cationic polymer is mixed with the inorganic fine particles for covering by adsorption, a method in which the covered particles are coagulated for forming higher dimensionally coagulated particles or a method in which coarse particles formed by the mixing is dispersed by a dispersing machine to form uniform composite particles.

The cationic polymer is generally water-soluble since it has a water-soluble group. However, some of them are insoluble in water according to the composition of the copolymerized components. The slightly soluble ones can be employed by dissolving in a water-permissible organic solvent, though the water-soluble ones are preferable from the viewpoint of facility of the production.

The water-permissible organic solvent is an organic solvent capable of being dissolved in water in an amount of approximately not less than 10%, for example, alcohols such as methanol, ethanol, propanol and n-propanol, glycols such as ethylene glycol, Diethylene glycol and glycerol, esters such as ethyl acetate and propyl acetate, ketones such as acetone and methyl ethyl ketone, and amides such as N,N-dimethyl-formamide. In such the case, the using amount of the organic solvent is preferably-smaller than that of water.

The cationic polymer is employed usually in an amount of from 0.1 to 10 g, and preferably from 0.2 to 5 g, per square meter of the ink-jet recording sheet.

Various kinds of additive can be added to the-ink accepting layer and another layer provided according to necessity of the ink-jet recording sheet of the invention, and a image durability improving agent such as a UV absorbent, an anti-oxidant and an anti-spreading-agent is preferably contained.

For such the UV absorbent, the followings can be exemplified: anti-oxidant and antispreading agent, alkylphenol compounds including hindered phenol compounds, alkylthiophenol compounds, hydroquinone compounds, alkylized hydroquinone compounds, tocopherol compounds, thiodiphenyl ether compounds, compounds each having two or more thioether bonds, bisphenol compounds, O—, N— and S-benzyl compounds, hydroxybenzyl compounds, triazine compounds, phosphonate compounds, acylaminophenol compounds, ester compounds, amide compounds, ascorbic acid, amine type antioxidant, 2-(2-hydroxyphenyl)benzotriazole compounds, 2-hydroxy-benzophenone compounds, acrylate compounds, water-soluble and hydrophobic metal salts organic metal compounds, metal complexes, hindered amine compounds including compounds so-called TEMPO, 2-(2-hydroxphenyl)-1,3,5-triazine compounds, metal inactivation compounds, phosphite compounds, phosphonite compounds, hydroxylamine compounds, nitron compounds, peroxide scavengers, polyamide stabilizers, polyether compounds, basic assistant stabilizers, nucleation agent, benzofranone compounds, indolinone compounds, phosphine compounds, polyamine compounds, thiourea compounds, urea compounds, hydrazide compounds, amidine compounds, succharides, hydroxybenzoic acid compounds and trihydroxybenzoic acid compounds.

Among them, alkylized phenol compounds, compounds having two or more thioether bonds, bisphenol compounds, ascorbic acid, amine type antioxidants, water-soluble and hydrophobic metal salts, organic metal compounds, organic complexes, hindered amine compounds, hydroxylamine compounds, polyamine compounds, thiourea compounds, urea compounds, hydrazide compounds, hydroxybenzoic acid compounds and trihydroxybenzoic acid compounds are preferable.

Moreover, organic latex fine particles of polystyrene, polyacrylates, polymethacrylates, polyacrylamides, polyethylene, polypropylene, polylvinyl chloride), poly(vinylidene chloride) and copolymers of them, urea resin or melamine resin, oil droplets of liquid paraffin, dioctyl phthalate, tricresyl phosphate or silicon oil, various kinds of cationic or nonionic surfactant, UV absorbent described in JP-A No. 57-74193, 57-87988 and 62-261476, color fading preventing agents described in JP-A No. 57-74192, 57-87989, 60-72785, 61-146591, JP-A No. 1-95091 and 3-13376, fluorescent whitening agent described in JP-A No. 59-42993, 59-52689, 62-280069 and 61-242871, and JP-A No. 4-219266, pH controlling agents such as sulfuric acid, phosphoric acid, citric acid, sodium hydroxide, potassium hydroxide and potassium carbonate, and various know additives such as defoaming agents, preservatives, thickeners, antistatic agent and matting agents may be added.

The support to be employed in the recording sheet of the invention is described below. Though there is no limitation on the support capable of being employed in the recording sheet of the invention, the use of water absorbing support such as paper tends to cause cockling by lowering in the flatness of the support. Furthermore, there is problem that the water resistivity, anti-spreading ability and image density can be lowered by diffusion of the zirconium compound or the aluminum compound. Accordingly, the use of a non-water absorbable support is preferable for enhancing the effects of the invention.

Know support usually employed for ink-jet recording sheet can be applied in the invention.

Sheet or plate of usual paper, cloth or wood can be employed in the invention as the support, and the paper is most preferable because which is superior in the water absorbing ability itself and in the cost. As the paper support, ones principally made from wood pulp such as chemical pulp such as LBPK and NBKP, machine-made pulp such as GP, CGP, RMP, TMP, CTMP, CMP and PGW, and old paper pulp such as DIP are employable. Various fiber-like material such as synthesized pulp, synthesized fiber and inorganic fiber can be optionally employed for the raw material according to necessity.

Various known additives such as sizing agents, pigments, paper strengthen agents, fixing agents, fluorescent whitening agents, wetting strengthen agents and cationizing agent can added according to necessity.

The paper can be produced by mixing the fiber like materials and the various additives and making paper by a paper mill such as a Foundrinier paper machine, a cylinder paper machine and a twin-wire paper machine. A size press treatment, a coating treatment or a calendaring treatment can be applied in the paper making process or by the paper machine.

In the invention, non-water absorbing support such as a plastic film support and a support of paper laminated by plastic resin film on both sides thereof are preferably usable.

Examples of the plastic film support include polyester film, poly(vinyl chloride) film, polypropylene film, cellulose triacetate film, polystyrene film and a laminated film thereof. Transparent and semitransparent films can be employed.

Particularly preferable support in the invention is the support of paper laminated with plastic resin on both sides thereof, and the most preferable one is paper laminated with polyolefin resin on both sides.

The water non-absorbable paper laminated with polyethylene as the most preferable typical olefin resin is described below.

The substrates to be employed in the paper support is made by using wood pulp as the principal raw material to which synthesized pulp such as polypropylene pulp or synthesized fiber such as that of nylon or polyester is added according to necessity. As the wood pulp, any of LBPK, LBSP, NBKP, NBSP, LDP, NDP, LUPK and NUPK can be used, and TBPK, NBSP, LBSP, NDP and LDP each containing many short fiber component is preferably used in larger amount. However, the ratio of LBSP or LDP is preferably from 10 to 70% by weight.

Chemical pulp containing small amount of impurity such as sulfate pulp and sulfite pulp is preferably employed, and pulp whitened by bleaching treatment can also be employed.

A sizing agent such as a higher fatty acid and an alkylketen dimer, a white pigment such as calcium carbonate, talk, titanium oxide, a paper strengthen agent such as starch, polyacrylamide and poly(vinyl alcohol), a water holding agent such as poly(ethylene glycol, a dispersing agent and a softening agent such as quaternary ammonium can be optionally added to the substrates.

The freeness of the pulp to be used for paper making is preferably from 200 to 500 ml according to the rule of CSF, and the fiber strength after beating in terms of the sum of the remaining component on 24-mesh and that on 42-mesh according to the rule of JIS-S-8207 is preferably from 30 to 70% by weight. The remaining component on 4-mesh is preferably not more than 20% by weight.

The weight of the paper is preferably 50 to 250 g, and more preferably from 70 to 200 g, per square meter. The thickness of the paper is preferably from 50 to 210 μm. The substrates can be provided high smoothness by calender treatment. The density of the paper is usually from 0.7 to 1.2 g/cm³ according to the rule of JIS-P-8118. The stiffness of the paper is preferably 20 to 200 g under the condition described in JIS-P-8143. Sizing agents the same as those to be added into the paper can be coated on the surface of the paper as the surface sizing agent. The pH of the paper is preferably from 5 to 9 when it is measured by the hot water extraction method described in JIS-P-8113.

The polyethylene for laminating the surface and back surface of the substrates is principally low density polyethylene (LDPE) or high density polyethylene (HDPE), and another resin such as LLDPE and polypropylene can be partially employed.

The polyethylene layer coated on the side on which the ink receiving layer is coated is preferably improved in the opacity and the whiteness by the addition of rutile type or anatase type titanium oxide as like as widely applied in photographic paper. The content of the titanium oxide is from 1 to 20%, and preferably from 2 to 15%, by weight to the polyethylene.

A pigment or a fluorescent whitening agent each having high thermal resistivity can be added to the polyolefin layer for controlling the color of white background. Examples of such the colorant include ultramarine, Prussian blue, cobalt blue, phthalocyanine blue, manganese blue, cerulean, tungsten blue, molybdenum blue and anthraquinone blue. Examples of the fluorescent whitening agent include dialkylaminocoumalin, bisdimethylaminostilbene, bismethylaminostilbene, 4-alkoxy-1,8-naphthalenedicarboxylic acid-N-alkylimide, bisbenzoxazolylethylene and dialkylstilbene.

The usual thickness of the polyethylene layer on the ink receiving layer side is from 15 to 50 μm, and that on the backing layer side is from 10 to 40 μm, though the using amounts of the polyethylene on the surface side and the back side are decided so as to optimize the curling under low and high humidity after providing the ink receiving layer and the backing layer. The ratio of the polyethylene on the surface side to that on the back side is preferably decided for controlling the curling which is varied depending on the thickness and the kind of the ink receiving layer and the thickness of the substrates, and is usually from 3/1 to 1/3 in the thickness.

The polyolefin layers each having various surface properties can be employed, in concrete, a support having mirror surface, a polyolefin laminated paper for glossy paper such as a support described in JP-A No. 2001-63204, for example, which is subjected to fine granulating treatment so as to have suitable glossiness, and a support having linen or mat surface by embossing treatment such as those described in JP-A No. 2000-296667, 2000-296669, 2001-347748 and 2001-63205, for example, can be employed in the invention.

The moisture content of the substrates is preferably from 5 to 8% by weight from the viewpoint of the stability.of curling. When the moisture content is less than 5% by weight, waving during storage under high humidity tends to be larger and when it is more than 8% by weight, curling tends to be larger during storage under low humidity.

The polyethylene laminated paper support has the following characteristics.

1) Stensile strength: Preferably from 20 to 300 N in the longitudinal direction and from 10 to 200N in the latitudinal direction according to the measuring method described in of JIS-P-8113

2) Tear strength: Preferably from 0.1 to 2 N in the longitudinal direction and from 0.2 to 2 N in the latitudinal direction according to the measuring method described in JIS-P-8116.

3) Compression elastic modulus: ≧9.8 kN/cm^{2 p}

4) Bekk smoothness of the surface side: Though a smoothness of not less than 500 seconds according to the condition described in JIS-P-8119 is preferable for glossy surface, it may be lower than that for a embossed product.

5) Bekk smoothness of the backside: A smoothness of from 100 to 800 seconds according to the condition described in JIS-P-8119 is preferable.

6) Opacity: A visible ray transmittance of not less than 20%, and particularly not more than 15%, measured under the measuring condition of (specular incident light)/(diffuse transmitted light) is preferable.

7) Whiteness: A Hunter whiteness described in JIS-P-8123 of not less than 90% is preferable, and L* of from 90 to 98, a* of from −5 to +5 and b* of from −10 to +5 are preferable, which are measured by the method of JIS-Z-8722 (containing no fluorescent agent) or that of JIS-Z-8717 (containing a fluorescent agent) and expressed by the color expression method described in JIS-Z-8730.

A subbing layer may be provided on the ink receiving layer side of the support for improving the adhesion between the ink receiving layer and the support. A hydrophilic polymer such as gelatin, poly(vinyl alcohol) and a latex polymer having a Tg of from −30 to 60° C. are preferable for the binder of the subbing layer. The binder is employed with in the range of from 0.001 to 2 g per square meter. In the subbing layer, a little amount of an anti-static agent such as a known cationic polymer can be added for preventing static charge.

A backing layer may be provided on the surface of the support opposite to the ink receiving layer for improving the slipping ability and the anti-static ability. A hydrophilic polymer such as gelatin, poly(vinyl alcohol) and a latex polymer having a Tg of from −30 to 60° C. are preferable for the binder of the backing layer, and an antistatic agent, various kinds of surfactant and a matting agent having an average particle diameter of approximately from 0.5 to 20 μm can be added to the baking layer. The thickness of the backing layer is about from 0.2 to 1 μm, and about from 1 to 20 μm when the backing layer is provided for preventing the curling. The backing layer may be constituted by two or more layers.

The ink-jet recording sheet is produced by a method in which the constituting layers such as the outermost layer containing the fumed titania according to the invention and the ink accepting layer containing the silica, for example, are coated and dried separately or simultaneously on the support by a method suitably selected from known methods. Examples of the coating method include a roller coating method, a rod bar coating method, an air-knife coating method, a spray coating method a curtain coating method, a slide bead coating method using a slide hopper described in U.S. Pat. Nos. 2,761,419 and 2,762,791.

The viscosity of the coating liquids for simultaneously coating two or more constituting layers by the slide bead coating method is preferably from 5 to 100 mPa·s, and more preferably from 10 to 50 mPa·s. When the curtain coating method is applied, the viscosity is preferably from 5 to 1200 mPa·s, and more preferably from 25 to 500 mPa·s.

The viscosity of the coating liquid at 15° C. is preferably not less than 100 mPa·s, more preferably from 100 to 30,000 mPa·s, further preferably from 3,000 to 30,000 mPa·s, and most preferably 10,000 to 30,000 mPa·s.

The ink-jet recording sheet produced by the method in which the outermost layer containing the fumed titania according to the invention and the lower porous ink receiving layer containing the silica for example, are simultaneously coated is excellent in the cost of course and also in the appearance since the interference of light at the interface of the layers is not caused.

Accordingly, the prima particle diameter of the fumed titania is necessary to be not more than 20 nm because the viscosity of the coating liquid is not increase when the particle size of the titania is large since the surface area of the particle becomes small. Therefore, the large size titania is not suitable for simultaneously coating using the slide hopper.

In preferable coating and drying method, the coating liquids are simultaneously coated and the resultant coating layer is once cooled by a temperature of from 1 to 15° C. and then dried at a temperature of not less than 10° C. The preparation, coating and drying of the coating liquids are preferably carried out at a temperature not more than the Tg of the thermoplastic resin so that the thermoplastic resin does not form a film. It is more preferable that the drying is carried out at a wet bulb temperature of from 5 to 50° C. and a layer surface temperature of from 10 to 50° C. The cooling after the coating is preferably carried out by a horizontal set method from the viewpoint of the uniformity of the coated layer.

The production process preferably includes a process for standing the product after coating and dried, for a period of from 24 hours to 60 days at a temperature of from 35° C. to 70° C.

Though the heating condition is not specifically limited as long as that the treatment is carried out under the condition of a period of from 24 hours to 60 days at a temperature of from 35° C. to 70° C., for a preferable example, the condition is from 3 days to 4 weeks at 36° C., from 2 days to 2 weeks at 40° C. or from 1 to 7 days at 55° C. By such the heating treatment, the hardening reaction and the crystallization of the water-soluble binder can be accelerated so as to attain the suitable ink absorbing ability.

A recording method employing an aqueous ink is preferably applied to the image recording using the ink-jet recording sheet according to the invention.

The aqueous ink is a recording liquid comprising a colorant, a solvent and another additive. As the colorant, known colorants for the ink-jet recording including water-soluble dyes such as direct dyes, acid dyes, basic dyes, reactive dyes and water dispersible pigments are employable.

For the solvent of the aqueous ink, water and various water-soluble organic solvent can be employed and polyhydric alcohols such as diethylene glycol, triethanolamine and glycerol and lower alkyl ether of polyhydric alcohol such as triethylene glycol monobutyl ether are preferable.

Other additives for the aqueous ink are, for example, a pH controlling agent, a metal blocking agent, an anti-mold agent, a viscosity controlling agent, a surface tension controlling agent, a wetting agent, a surfactant and a rust preventive.

The aqueous ink preferably has a surface tension of from 25 to 60 mN/m, and preferably from 30 to 50 mN/m. The pH of the aqueous ink is preferably from 5 to 10, and particularly from 6 to 9.

### EXAMPLES

The invention is described referring examples below, and the invention is not limited to the examples.

<Preparation of Fumed Titania>

Fumed titania was prepared by the following procedure. Titanium tetrachloride in a gas state was hydrolyzed by heating in the presence of oxygen-hydrogen gas at a temperature of 1,200° C. and a titanium concentration in the raw material gas of 60 g/m³ in terms of titanium dioxide (titania). Thus fine particles of titanium oxide were obtained which has an average particle diameter of 18 nm and a BET specific surface area of 70 cm²/g.

Besides, titanium oxide fine particles having an average particle diameter of 9 nm and a BET specific area of 150 cm²/g were obtained by changing the temperature to 1,500° C. and the titanium concentration to 10 g/m³.

The above two kinds of fumed titania are each referred in Table 1 as titania (18 nm) and titania (9 nm), respectively.

Fumed titania P25, manufactured by Nihon Aerogil Co., Ltd., having an average particle diameter of 21 nm and a BET specific area of 50 cm²/g was used for comparison.

<<Preparation of Recording Sheet>>

(Preparation of Recording Sheet 1)

Four hundreds liters of silica dispersion B-1 containing 22% of Vapor deposited silica previously dispersed into a uniform state having an average primary particle diameter of 0.007 μm, Aerogil 300 manufactured by Nihon Aerogil Co., Ltd., and 0.6 liters of anionic fluorescent whitening agent Uvitex NFW Liquid, manufactured by Chiba specialty Chemicals Co., Ltd., was added to 110 liters of an aqueous solution containing 12% of cationic polymer P-1, 10% of n-propanol and 2% of ethanol while stirring at 3,000 rpm at room temperature. After that, 54 liters of an aqueous solution A-1 of a mixture of boric acid and borax in a ratio of 1:1 (the concentration was each 3% by weight) was gradually added to the resultant liquid while stirring.

After that, the above mixture was dispersed by a high pressure homogenizer, manufactured by Sanwa Kogyo Co., Ltd., with a pressure of 3 kN/cm², and made up to 630 liters by purified water to obtain almost transparent silica dispersion-D-1. 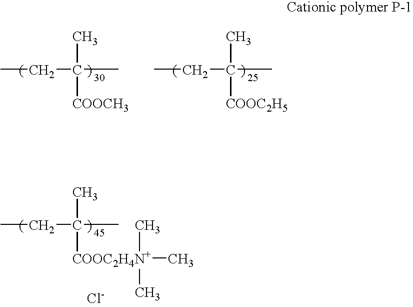
(Preparation of Silica Dispersion D-2)

Silica dispersion D-2 was prepared in the same manner as in silica dispersion D-1 except that the anionic fluorescent whitening agent and the cationic polymer P-1 were omitted.

(Preparation of Silica Dispersion D-3)

Silica dispersion D-3 was prepared in the same manner as in silica dispersion D-2 except that an aqueous solution of basic aluminum chloride, Takibain #1500 having an Al₂O₃ content of 23.75% and a basic degree of 83.5% manufactured by Taki Kagaku, Co., Ltd., was mixed so that the ratio of vapor deposited silica/Al₂O₃ was 5.6.

The dispersed states of silica dispersions D-1 and D-3 were observed by the method described in JP-A No. 11-321078. As a result of that, it could be confirmed that the silica particle was extremely stable cation-modified composite particle.

The above prepared silica dispersions D-1 through D-3 was each filtered by TCP-30 type filter having a filtering accuracy of 30 μm manufactured by Advantec-Toyo Co., Ltd.

(Preparation of Ink Receiving Layer Coating Liquid)

Ink receiving layer coating liquids for forming porous layer were prepared by employing each of the above prepared silica dispersions, respectively, and successively adding the following additives. The adding amount is described in the amount per liter.

(First ink receiving layer coating liquid: Lower layer)

| | | |
|---|---|---|
| Silica dispersion D-1 | 650 | ml |
| 8.0% aqueous solution of polyvinyl alcohol | 250 | ml |
| (Average polymerization degree: 3,800, saponification | | |
| degree: 88%) | | |
| 4% aqueous solution of Surfactant (Ftergent 400S, Neos | 2.0 | ml |
| Co., Ltd.) | | |
| Make to 1000 ml by purified water | | |

(Second ink receiving layer coating liquid: Outermost layer)

| | | |
|---|---|---|
| Silica dispersion D-2 | 630 | ml |
| 8.0% aqueous solution of polyvinyl alcohol | 250 | ml |
| (Average polymerization degree: 3,800, saponification | | |
| degree: 88%) | | |
| 6% aqueous solution of surfactant (Quartamin 24P, Kao | 3.0 | ml |
| Co., Ltd.) | | |
| 4% aqueous solution of Surfactant (Ftergent 400S, Neos | 1.0 | ml |
| Co., Ltd.) | | |
| Make to 1000 ml by purified water | | |

Each of the ink receiving-layer coating liquids was filtered by TCPD-30 filter, manufactured by Advantec-Toyo Co., Ltd., having a filtering accuracy of 20 μm and further filtered by TCPD-10 filter.

[Preparation of Recording Sheet]

Recording sheet No. 1 was prepared by coating the second ink receiving layer coating liquid by solid hopper coating so that the dry layer thickness described in Table 1 was formed.

Recording sheets No. 2 through No. 7 were each prepared by using the second ink receiving layer coating liquids, respectively in each of which the vapor deposited silica Aerogil 300, manufactured by Nihon Aerogil Co., Ltd., was replace by the same amount of the inorganic particle described in Table 1. The coating liquid were each coated by the slide hopper so as to form the layers each having the dry thickness described in Table 1.

No. 8 through No. 18 are double layer recording sheet samples each having the first and second layers, in which the silica dispersion in the second ink receiving layer was changed to D-3. Ones described as one-pass in Table 1 were prepared by simultaneously coating the lower layer (the first layer) and the outermost layer (the second layer) by a slide hopper, and ones described as two-pass were prepared by the first pass coating (the lower layer) by the slide hopper and the second-pass coating (the outermost layer) by a wire bar.

The first layer was formed by the ink receiving layer coating liquid containing the silica as the inorganic particle and the second layer (the outermost layer) was only changed. Namely, ink receiving layer coating liquids were employed in each of which the vapor deposited silica (Aerogil 300, manufactured by Nihon Aerogil Co., Ltd.) in the silica dispersion D-3 in the second ink receiving layer coating liquid was changed by the inorganic particles described in Table 1.

In the preparation of the ink receiving layer coating liquid, the titania in an amount of 1.7 times of that of the silica was mixed when the titania was employed as the inorganic fine particle.

In recording sheet sample No. 16, the following cationic polymer P-2 was employed in an amount of 5% by weight of the fumed titania in place of PAC (Takibain #1500, manufactured by Taki Kagaku Co., Ltd.) in the second ink receiving layer coating liquid.

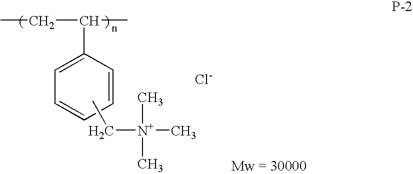

The thickness of each of the layers is listed in Table 1.

The viscosity of each of the coating liquids in mPa·s is also listed in Table 1. In the double-layer samples No. 11 and 12, the first ink receiving layer coating liquid for each of the samples was diluted so that the viscosity becomes to that described in Table 1 for forming thin outermost layer.

The following RC paper having a width of 1.5 m and a length of 4,000 m and wound into a roll was employed as the support.

The RC paper was prepared by the process in which the surface of photographic substrates having a moisture content of 8% and a weight of 170 g was laminated by a polyethylene layer containing 6% of anatase type titanium oxide layer of 35 μm by melt-extrusion coating and the back surface of that was laminated by a polyethylene layer of 35 μm by the melt extrusion coating. The surface side of the RC paper was subjected to corona discharge, and 0.05 g/m² of polyvinyl alcohol PVA235, manufactured by Kuraray Co., Ltd., was coated on it as a subbing layer. The backside was treated by corona discharge and a back-coating layer containing about 0.4 g of styrene-acrylate type latex binder having a Tg of approximately 80° C., 0.1 g of an anti-static agent (cationic polymer) and 0.1 g of silica matting agent of about 2 μm was coated on it.

In samples No. 17 and 18, RC paper having linen surface by embossing was employed. The drying after coating the ink receiving layer coating liquid was performed by passing for 15 seconds through a cooling zone held at 5° C. for cooling the layer surface by 13° C., and drying through plural drying zones each set at suitable temperature. After that, the coated material was wound up into a roll to obtain each of the recording sheet. Thus obtained recording sheet samples No. 1 through 18 were evaluated by the following methods.

(Coating Stability)

The coating stability on the occasion of double layer coating of recording sheet samples Nos. 8 trough 18 was evaluated from the viewpoints of spreading on the sliding surface and disordering of the liquid surface by the drying wind.

A: Coating can be stably carried out with good spreading on the sliding surface and without disordering of the liquid surface.

B: The coating barely can be carried out although a little ununiformity was formed in the spreading of the coating liquid on the sliding surface.

C: The coating was instable and ununiformity occurred on the coated layer. The evaluation was carried out by using a relatively uniform portion of the coated samples.

—: Not evaluated because the coating was carried out by the wire bar without sliding surface.

(Interference Phenomenon)

The light interference was visually observed under sun light with respect to the double layer samples Nos. 8 to 18.

A: Any interference was not noticed by observation at a distance of 30 cm.

B: Weak stripes of red through green were observed at a distance of 30 cm.

C: The surface was entirely light in red, orange or green.

—: Not evaluated since the sample has only single layer.

(Glossiness Before Printing)

The glossiness at 60 was measured according to JIS-Z-8741 by a variable angle glossiness meter VSG-1001DP, manufactured by Nihon Den'i Kogyo Co., Ltd.

(Ink Absorbing Speed)

An image was printed on the sample by an ink-jet printer PM3000C, manufactured by Seiko Epson Co., Ltd., and the ununiformity of the printed image was visually observed and classified as follows as the criterion of the ink absorbing speed.

A: Ununiformity in the image was not observed at all.

B: Uniformity in the image was partially observed.

C: Uniformity in the image was observed.

Samples classified into A and B were acceptable for practical use.

(Coloring Ability of Dye Print)

An image was printed by an ink-jet printer PM-900C, manufactured by Seiko-Epson Co., Ltd., and the reflective density of black solid image was evaluated. The reflective density was measured by a spectral calorimeter densitometer X-Rite 938, manufactured by Nihon Heihan Kizai Co., Ltd.

(Glossiness Uniformity of Pigment Printed Image)

The difference between the glossiness of a cyan solid image having a density d of 0.6±0.05 printed by an ink-jet printer PX-6000 and that before the printing was determined. The glossiness at 60° was measured according to JIS-Z-8741 by a variable angle glossiness meter VSG-1001DP, manufactured by Nihon Den'i Kogyo Co., Ltd., in the same manner as in the foregoing item.

The constitutions and the evaluation results of the prepared samples were listed in Table 1.

TABLE 1

| | | Particle | | Dry layer | Lower layer | | | | | | | | | |
|---|---|---|---|---|---|---|---|---|---|---|---|---|---|---|
| | Inorganic | diameter | | thickness | thickness | Coating | | | | | | | | |
| No. | particle | (nm) | Cation | (μm) | (μm) | method | *3 | *4 | *5 | *6 | *7 | *8 | *9 | Remarks |
| 1 | Fumed silica | 7 | None | 20 | None | — | 180 | — | 35 | — | A | 2.2 | 60 | Comparative |
| 2 | Fumed titania | 18 | None | 20 | None | — | 80 | — | 47 | — | A | 1.8 | 20 | Inventive |
| 3 | P25 | 21 | None | 20 | None | — | 30 | — | 42 | — | A | 1.5 | 20 | Comparative |
| 4 | TSK-5 | *1 | None | 20 | None | — | 15 | — | 65 | — | C | 1.8 | 30 | Comparative |
| 5 | N-40 | 8 | None | 20 | None | — | 20 | — | 60 | — | C | 1.8 | 25 | Comparative |
| 6 | Fumed titania | 9 | None | 20 | None | — | 150 | — | 50 | — | A | 1.9 | 15 | Inventive |
| 7 | *2 | 9 | None | 20 | None | — | 160 | — | 40 | — | A | 2.1 | 30 | Inventive |
| 8 | Fumed titania | 9 | PAC | 1 | 36 | One-pass | 60 | A | 50 | A | A | 2.2 | 15 | Inventive |
| 9 | P25 | 21 | PAC | 1 | 36 | One-pass | 15 | C | 47 | A | A | 1.8 | 15 | Comparative |
| 10 | N-40 | 8 | PAC | 1 | 36 | One-pass | 5 | C | 53 | A | C | 2.1 | 20 | Comparative |
| 11 | Fumed titania | 9 | PAC | 0.5 | 36 | Two-pass | 3 | — | 50 | B | A | 2.2 | 15 | Inventive |
| 12 | Fumed titania | 9 | PAC | 0.1 | 36 | One-pass | 30 | B | 50 | A | A | 2.2 | 15 | Inventive |
| 13 | Fumed titania | 9 | PAC | 4 | 36 | One-pass | 60 | A | 50 | A | A | 2 | 15 | Inventive |
| 14 | Fumed titania | 9 | PAC | 6 | 36 | One-pass | 60 | A | 45 | A | A | 1.8 | 20 | Inventive |
| 15 | Fumed titania | 9 | PAC | 1 | 36 | Two-pass | 60 | — | 45 | B | A | 2.2 | 20 | Inventive |
| 16 | Fumed titania | 9 | P-2 | 1 | 36 | One-pass | 40 | A | 50 | A | A | 2.1 | 15 | Inventive |
| 17 | Fumed titania | 9 | PAC | 1 | 36 | One-pass | 60 | A | 18 | A | A | 2.2 | 6 | Inventive |
| 18 | Fumed silica | 7 | PAC | 1 | 36 | One-pass | 80 | A | 13 | A | A | 2.2 | 40 | Comparative |

*1: Needle-like crystal of 10 × 40 nm
*2: Fumed titania:Fumed silica = 1:1, (particle diameter of silica is 7 nm)
*3: Viscosity of coating liquid (mPa · s),
*4: Coating stability,
*5: Glossiness before printing (60°),
*6: Interference phenomenon,
*7: Absorbing speed,
*8: Coloring ability of dye printing,
*9: Glossiness uniformity of pigment printing,
P-25: Fumed titania P25, manufactured by Nihon Aerogil Co., Ltd.
TSK-5: Titania sol, manufactured by Ishihara Techno Co., Ltd.
N-40: Titanium oxide sol, Tainoc N-40, manufactured by Taki Kagaku Co., Ltd.
PAC: Basic aluminum chloride, Takibain #1500, manufactured by Taki Kagaku Co., Ltd.

As above-mentioned, the ink-jet recording sheet according to the invention is superior in the surface glossiness and the coloring ability for the dye ink, and image uneveness is not caused in the recording sheet because the ink is rapidly absorbed. Moreover, it is understood that the recording sheet is excellent in the uniformity of glossiness when the image is printed by the pigment ink.

What is claimed is:

1. An ink-jet recording sheet containing titanium oxide particles at the outermost surface thereof wherein the titanium oxide particles are the fumed titania particles and have a primary particle diameter of not more than 20 nm.

2. The ink-jet recording sheet of claim 1, wherein the recording sheet has two or more ink receiving layers on a support and the layer constituting the outermost ink receiving surface contains the fumed titania particles having a primary particle diameter of not more than 20 nm, and has a thickness of from 0.1 to 5 μm.

3. The ink-jet recording sheet of claim 2, wherein the layer constituting the ink receiving outermost surface contains the fumed titania particles having a primary particle diameter of not more than 20 nm, and has a thickness of from 0.1 to 5 μm, and is formed by simultaneously coated with the adjacent ink receiving layer.

4. The ink-jet recording sheet of claims 1, wherein the layer containing the fumed titania particles contains a cationic compound.

5. The ink-jet recording sheet of claim 4, wherein the cationic compound is basic polyaluminum chloride.
